(19) United States
(12) Patent Application Publication
(10) Pub. No.: US 2018/0308507 A1
(43) Pub. Date: Oct. 25, 2018

(54) AUDIO SIGNAL PROCESSING WITH LOW LATENCY

(71) Applicant: Dolby Laboratories Licensing Corporation, San Francisco, CA (US)

(72) Inventors: Zhiwei SHUANG, Beijing (CN); David S. MCGRATH, Rose Bay, New South Wales (AU); Michael William MASON, Wahroonga, New South Wales (AU)

(73) Assignee: Dolby Laboratories Licensing Corporation, San Francisco, CA (US)

(21) Appl. No.: 15/776,718

(22) PCT Filed: Jan. 13, 2017
(86) PCT No.: PCT/US2017/013522

§ 371 Date: May 16, 2018

Related U.S. Application Data
(60) Provisional application No. 62/279,111, filed on Jan. 15, 2016.

(30) Foreign Application Priority Data
Jan. 15, 2016 (CN) 201610024139.9
Jan. 15, 2016 (EP) 16151480.7

(51) Int. Cl. G10L 25/18; G10L 25/21; H04R 3/04

(52) U.S. Cl. CPC G10L 25/18; H04R 3/04; G10L 25/21

(57) ABSTRACT

Example embodiments disclosed herein relate to audio signal processing with low latency. A method of processing an audio signal is disclosed. The method includes obtaining frequency parameters of a current frame of the audio signal. The method also includes generating intermediate frequency domain outputs for a set of predefined frequency bands based on the frequency parameters using predefined frequency band filter banks, a frequency band filter bank being specific to a respective frequency band in the set. The method further includes determining frequency band energies for the set of predefined frequency bands based on the intermediate frequency domain outputs, and processing the current frame based on the determined frequency band energies. Corresponding system, computer program product, and device for processing an audio signal are also disclosed.

### TECHNOLOGY

Example embodiments disclosed herein generally relate to audio signal processing and more specifically, to a method and system for device specific audio signal processing with low latency.

### BACKGROUND

In order to play back audio signal with good quality, it is generally necessary to process the audio signal. For example, the audio signal may be processed according to the characteristics or parameters of a target playback device. Such processing is referred as device specific or centric audio signal processing. In general, the device specific audio signal processing involves anything related to presentation and calibration according to the playback device and/or environment. Typically, the device specific audio signal processing may include equalizer processing, regulator processing, peak limiting processing, and so forth. As an example, if the playback device has a limited capacity of reproducing the high frequency component of the audio signal, then the audio signal can be processed to suppress the high frequency component accordingly to avoid any clicks, distortions or any other audible artifacts in the playback. Of course, it will be appreciated that the audio signals may be processed for any other purposes.

For some cases, such as VoIP (Voice over Internet Protocol) communications and gaming, latency of the audio signal processing is a significant factor. Long latency of the audio signal processing is very likely to decrease the overall performance of the application and has negative impact on user experience. However, at present, solutions for audio signal processing usually cannot minimize the latency due to the consideration of fidelity. More specifically, the audio signal processing generally includes transforms between time domain and frequency domain. For example, the audio signal may be transformed from the time domain to the frequency domain to obtain a series of frequency coefficients. The frequency coefficients can be modified according to the characteristics of the playback device. Then, the audio signal with the modified coefficients is transformed back to the time domain for playback. There is a tradeoff between audio processing latency and computation efficiency. To achieve high resolution in the filter's frequency response, known approaches have to operate with high computation cost or significant latency. Moreover, in order to allow a fine level control of all frequency parameters, existing solutions usually introduce higher distortion or longer latency.

In view of the foregoing, there is a need for a solution of audio signal processing with low latency.

### SUMMARY

Example embodiments disclosed herein propose a solution of audio signal processing with low latency.

In one aspect, example embodiments disclosed herein provide a method of processing an audio signal. The method includes obtaining frequency parameters of a current frame of the audio signal. The method also includes generating intermediate frequency domain outputs for a set of predefined frequency bands based on the frequency parameters using predefined frequency band filter banks, a frequency band filter bank being specific to a respective frequency band in the set. The method further includes determining frequency band energies for the set of predefined frequency bands based on the intermediate frequency domain outputs and processing the current frame based on the determined frequency band energies. Embodiments in this regard further provide a corresponding computer program product.

In another aspect, example embodiments disclosed herein provide a system for processing an audio signal. The system includes a parameter obtaining unit configured to obtain frequency parameters of a current frame of the audio signal. The system also includes an intermediate output generating unit configured to generate intermediate frequency domain outputs for a set of predefined frequency bands based on the frequency parameters using predefined frequency band filter banks, a frequency band filter bank being specific to a respective frequency band in the set. The system further includes a band energy determining unit configured determine to frequency band energies for the set of predefined frequency bands based on the intermediate frequency domain outputs and a frame processing unit configured to the current frame based on the determined frequency band energies.

In yet another aspect, example embodiments disclosed herein provide a device. The device includes a processing unit and a memory storing instructions that, when executed by the processing unit, cause the device to perform the method as described above.

Through the following description, it will be appreciated that in accordance with example embodiments disclosed herein, a predefined frequency band filer bank specific to a frequency band is used to process the frequency parameters to generate the intermediate frequency domain outputs, so that the frequency parameters are adapted for the frequency band. The frequency band energy for the frequency band may then be estimated based on the intermediate frequency domain outputs for this frequency band. In this way, the estimated frequency band energy may reflect the specific characteristic of each frequency band correctly, which will be advantageous for the subsequent audio signal processing. Other advantages achieved by example embodiments disclosed herein will become apparent through the following descriptions.

### DESCRIPTION OF DRAWINGS

Through the following detailed description with reference to the accompanying drawings, the above and other objectives, features and advantages of example embodiments disclosed herein will become more comprehensible. In the drawings, several example embodiments disclosed herein will be illustrated in an example and non-limiting manner, wherein:

FIG. 1 is a flowchart of a method of processing an audio signal in accordance with one example embodiment disclosed herein;

FIG. 2 is a flowchart of a method of processing an audio signal in accordance with another example embodiment disclosed herein;

FIG. 3 is a block diagram of a system for processing an audio signal in accordance with one example embodiment disclosed herein;

FIG. 4 is a block diagram of a system for processing an audio signal in accordance with another example embodiment disclosed herein; and

FIG. 5 is a block diagram of an example computer system suitable for implementing example embodiments disclosed herein.

Throughout the drawings, the same or corresponding reference symbols refer to the same or corresponding parts.

### DESCRIPTION OF EXAMPLE EMBODIMENTS

Principles of example embodiments disclosed herein will now be described with reference to various example embodiments illustrated in the drawings. It should be appreciated that depiction of those embodiments is only to enable those skilled in the art to better understand and further implement example embodiments disclosed herein and is not intended for limiting the scope disclosed herein in any manner.

As used herein, the term “includes” and its variants are to be read as open-ended terms that mean “includes, but is not limited to.” The term “or” is to be read as “and/or” unless the context clearly indicates otherwise. The term “based on” is to be read as “based at least in part on.” The term “one example embodiment” and “an example embodiment” are to be read as “at least one example embodiment.” The term “another embodiment” is to be read as “at least one other embodiment”.

In audio processing systems, an audio signal can be processed by controlling frequency band gains for a set of predefined frequency bands of the audio signal. To determine the frequency band gains, frequency band energies for the respective frequency bands are needed to be estimated. One possible way is to determine the frequency band energies directly based on a series of frequency parameters of the audio signal. For a given frequency ban, the frequency band energy may be calculated as the sum of squares of the frequency parameters corresponding to the associated frequency bin(s), which may be represented as below:

$${E}_{p} ( b ) = {\sum }_{k = Bs}^{Be} {\vert {X}_{p} ( k ) \vert}^{2} \qquad ( 1 )$$

where Eₚ(b) represents the frequency band energy for the bth frequency band of the pth frame, Xₚ(k) represents the frequency parameter for the kth frequency bin of the pth frame, and Bₛ and Bₑ represent the first and last frequency bins associated with the bth frequency band, respectively.

Although the association between the frequency bin and the frequency band can be configured, it is usually determined based on the division of the frequency band and frequency bin in the frequency domain to ensure better frequency band energy estimate. The frequency bands to be operated may be defined and fixed in advance according to, for example, human auditory characteristics or models, and the bandwidth of each of the frequency bands may be the same or different. The division of the frequency bins may be related to the sampling rate and the length of the time-frequency transform. For example, if an audio signal is sampled at a sampling rate of 48000 Hz and the length of the time-frequency transform is 640, then a bandwidth between two successive frequency bins may be 48000 Hz/640=75 Hz. The frequency bin(s) covered by a frequency band may be determined as being associated with this band and the corresponding frequency parameter(s) may be used to estimate the frequency band energy for this band

In the audio signal processing, large latency may be due to the settings of the time-frequency processing parameters. Examples of the processing parameters may include a length of the time-frequency transform, the number of audio samples processed per iteration, and/or a length of crossfading. Although there are some known solutions to reduce the latency on the basis of given time-frequency processing parameter values, in order to provide lower latency, one straight forward solution is to use small processing parameter values, for example, use a shorter length of the time-frequency transform, the smaller number of audio samples processed per iteration, and/or a shorter length of the crossfading. In this situation, if the frequency band energies are still determined directly based on the frequency parameters as shown in Equation (1), it is found that the determined frequency band energies (especially the energies for the low frequency bands), are inaccurate. This will in turn affect the accuracy of the subsequent processing tasks.

If a shorter length of the time-frequency transform is used (for a given sampling rate), the frequency bins of the audio signal will become sparse. For example, in the case that the length of the time-frequency transform is reduced from 640 to 128, a bandwidth between two successive frequency bins may be 48000 Hz/128=375 Hz. Since the division of the frequency bands is generally fixed, each of the frequency bands will not cover a different number of frequency bins due to the sparse distribution of the frequency bins and thus the frequency band energies for some frequency bands are estimated as the same based on the frequency parameters corresponding to the associated frequency bins. For example, the first four frequency bands may cover the first frequency bin at 375 Hz and their frequency band energies may be estimated as the same, resulting in low resolution in the low frequency part of the audio signal.

According to example embodiments disclosed herein, there is provided a solution for more accurate frequency band energy estimate even in the cases of employing time-frequency processing parameters with low latency characteristic to process the audio signal. Reference is first made to FIG. 1, which depicts a flowchart of a method of processing an audio signal 100 in accordance with an example embodiment disclosed herein.

In step 110, frequency parameters of a current frame of the audio signal to be processed are obtained. In some embodiments, the audio signal may be input as a frequency domain signal. For example, the audio signal may be in the form of a series of frequency bins, each of which is represented as, for example, a complex number. The real and imaginary parts of each complex number may be used as the frequency parameters.

Alternatively or additionally, the frequency parameters may be derived by any suitable frequency analysis or processing on the input audio signal. The audio signal may be in the time domain and thus needs to be transformed into the frequency domain. The time-frequency transform may be based on time domain crossfading and any other time-to-frequency transform methods. In some embodiments, the time domain crossfading processing may be performed every S samples, where S is a natural number. The S samples may constitute a frame or a block of the audio signal. For each frame of the audio signal, S+C₀ samples may be obtained as input and S new audio output samples will be produced, where C₀ represents the length of crossfading. The crossfading processing may be implemented in various different manners employing currently known procedures or those developed in the future. Applying the crossfading will facilitate reducing distortions when generating the frequency band gains with a very low computation cost.

In some embodiments, the frame of the audio signal may be transformed to the frequency domain using a Modulated Discrete Fourier Transform (MDFT). In these embodiments, the frequency domain samples for the frame of the audio signal may be obtained by:

$${X}_{p} ( k ) = MDFT ( {x}_{p} ( n ) ) = {\sum }_{n = 0}^{2 N - 1} {x}_{p} ( n ) {e}^{- i π ( 2 k + 1 ) n / 2 N} \qquad ( 2 )$$

where Xₚ(k) represents the kth frequency domain sample of the pth frame, xₚ(n) represents the nth time domain sample of the pth frame, 2N represents the length of the time-frequency domain, and MDFT( ) represents the time-frequency transform. Alternatively, the transform may be a standard Discrete Fourier Transform (DFT) or any other suitable time-frequency transform. The scope of the subject matter disclosed herein is not limited in this regard.

With the time-frequency transform of MDFT, 2N real time domain samples may be transformed to N complex frequency domain samples, each of which can be considered as a frequency bin. It will be appreciated that depending on the used time-frequency transform, for a given length of time-frequency transform, the number of the transformed frequency domain samples (which is also corresponding to the number of the frequency bins) might be varied. Each frequency bin may be represented as a complex number, and the real and imaginary parts of each complex number may be used as the frequency parameters for the pth frame.

In some embodiments, in order to achieve low latency, small time-frequency processing parameter values may be used, for example, a small number of samples processed each time, a short length of time domain crossfading, and/or a shorter length of time-frequency transform may be used. By way of example, it may be set that S=48, C₀=4, and 2N=128. It will be appreciated that these values are given only for the purpose of illustration and any other suitable values can be used.

Next, in step 120 of the method 100, intermediate frequency domain outputs are generated for a set of predefined frequency bands based on the frequency parameters using predefined frequency band filter banks. Each of the frequency band filter banks may for example be specific to a respective frequency band in the set.

In example embodiments disclosed herein, the frequency bands may be defined in advance according to, for example, human auditory characteristics or models. For example, it is proved that the human users are sensitive to a certain range of frequency, for example, from 0 to 24 kHz. Accordingly, only the frequency bands within that range will be subject to the frequency domain processing. As such, example embodiments disclosed herein utilize a convenient, efficient simplification that conforms to the human hearing system, for example, the equivalent rectangular bandwidth (ERB) simplification, to facilitate reducing the latency. In some embodiments, the frequency range of 0-24 kHz may be divided into forty ERB bands and each of frequency bands to be processed may have a bandwidth of 2 ERB bands. It will be appreciated that this is only for the purpose of illustration and any other suitable frequency range and/or the number of bands can be used.

In order to estimate a frequency band energy for frequency band, according to example embodiments disclosed herein, instead of determining the frequency band energy directly based on the frequency parameters of the current frame, a predefined frequency band filter bank specific to the frequency band is used first to process the frequency parameters so as to generate the intermediate frequency domain outputs. The intermediate frequency domain outputs may then be used to estimate the frequency band energy for the frequency band.

As mentioned above, the frequency bands of the audio signal are predefined. Accordingly, the frequency band filter bank specific to each of the frequency bands of the audio signal also can be designed in advance. In general, such filter banks may be considered as a matrix composed of a real part Tᵣ and imaginary part Tᵢ, each of which is a complex array of frequency coefficients described as follows: N×M×B, where N represents the number of frequency bins, M represents a delay length which indicates how many frames prior to the current frame are taken into account, and B represents the number of frequency bands. In some embodiments, the frequency band filter banks may be designed as follows.

For each frequency band b∈[0,B−1], a desired impulse response t_{b}^{r}(n), which is a band-pass filter representing the response of frequency band b, may be constituted. The filter will be finite length which may be defined for n∈[0,L−1], where L=2N+(M−2)S−C₀+1. Optionally, for each frequency band b∈[0,B−1], it is also possible to make up a desired impulse response t_{b}ⁱ(n) which is a band-pass filter representing the 90-degree phase shifted response of the frequency band b. This filter will also be finite length defined for n∈[0,L−1].

Then, for each of the band filters t_{b}^{r}(n) and possibly t_{b}ⁱ(n), the long filter may be broken into several shorter chunks denoted as f_{b}ⁱ(n,m), where n∈[0,2N−S−C₀] and m∈[0,M−1]. For example, in an embodiment where N=64, S=48, M=5 and C₀=4, a filter of length L=2N+(M−2)S−C₀+1=269 may be broken into M=5 chunks, each of length 2N−S−C₀+1=77. The chunks will overlap each other by C_{F}=2N−2S−C₀+1=29 samples. Each impulse response chunk is then transformed into the frequency domain T_{b}^{r}(k,m)=F(t_{b}^{r}(n,m)) which can be considered as a frequency domain filter bank specific to the frequency band b. Similarly, T_{b}ⁱ(k, m) may be constructed. It will be appreciated that the above example is only for the purpose of illustration. Given a set of predefined frequency bands, the associated frequency band filters may be designed in various manners. The scope of the subject matter disclosed herein is not limited in this regard.

In conventional audio signal processing, the designed frequency band filter banks may be used to process the frequency band gains derived from the frequency band energies in real time so as to generate the frequency band bins for processing the current frame. Specifically, supposed that the frequency band gain of a given frequency band b is known as gₚ(b), with the frequency band gain as input, the frequency band filter bank specific to this frequency band may output the corresponding frequency bin gain. The output frequency bin gain may be determined by multiplying the frequency band gain by the complex array of the frequency coefficients of the frequency band filter bank. The determination of the frequency bin gain may be represented as follows:

$${F}_{p} ( k , m ) = {\sum }_{b = 0}^{B - 1} {T}_{b}^{r} ( k , m ) R ( {g}_{p} ( b ) ) + {T}_{b}^{i} ( k , m ) I ( {g}_{p} ( b ) ) \qquad ( 3 )$$

where Fₚ(k,m) represents the frequency bin gain for the pth frame and for the kth frequency bin of the mth delay frame, and R( ) and I( ) represent the functions for obtaining the real part and imaginary part of gₚ(b), respectively. In some embodiments where complex frequency band gains are not required, the imaginary part t may be omitted.

The final frequency domain output for the current frame may be generated by multiplying the frequency bin gains with the respective frequency bins, which may be represented as follows:

Yₚ(k)=Xₚ(k)Fₚ(k,m) (4)

where Yₚ(k) represents the frequency domain output for the kth frequency bin of the pth frame.

Alternatively, in order to take into consideration the impact of one or more previous frames, in some embodiments, the frequency domain output for the current frame may be generated based on the frequency bin gains for not only the current frame but also for at least one previous frame:

$${Y}_{p} ( k ) = {\sum }_{m = 0}^{M - 1} {X}_{p - m} ( k ) {F}_{p} ( k , m ) \qquad ( 5 )$$

as indicated above, M represents a delay length, indicating how many frames are taken into account. By combining Equation (3) with Equation (5) (or Equation (4) in the case where no previous frames are taken into account), it may be represented as:

$${Y}_{p} ( k ) = {\sum }_{m = 0}^{M - 1} {X}_{p - m} ( k ) ( {\sum }_{b = 0}^{B - 1} {T}_{b}^{r} ( k , m ) R ( {g}_{p} ( b ) ) + {T}_{b}^{i} ( k , m ) I ( {g}_{p} ( b ) ) ) \qquad ( 6 )$$

Based on the above audio signal processing, in example embodiments disclosed herein, the predefined frequency band filter banks specific to the frequency bands may also be used in estimating the frequency band energies. Specifically, the predefined frequency band filter banks may be used to process the frequency parameters of the current frame to generate intermediate frequency domain outputs. Based on the intermediate frequency domain outputs, the frequency band energy for each of the frequency bands may be determined.

In some embodiments disclosed herein, there may be frequency parameters associated with each of the predefined frequency bands. The frequency parameters associated with the frequency band may be those frequency parameters that are corresponding to the frequency bins associated with this frequency band. Each frequency band may be associated with at least one of the plurality of frequency bins of the current frame. In some embodiments, the frequency bins of the current frame may be allocated into different frequency bands, where each frequency band is associated one or more frequency bins. The association between the frequency bands and the frequency bins may be predefined and may be determined based on the division of the frequency bands and frequency bins in the frequency domain. As an example, the lowest frequency bin may be associated with the lowest frequency band, the second and third lowest frequency bins may be associated with the second lowest frequency band, and so on.

Then, by using the predefined frequency band filter bank specific to each of the frequency bands, the intermediate frequency domain outputs for the frequency band may be generated based on the frequency parameters corresponding to the associated at least one frequency bin. In some embodiments, among the plurality of frequency band filter banks specific to all the frequency bands of the current frame, i.e., among the matrix composed of a real part T^{r} and imaginary part Tⁱ with the size of N×M×B, a frequency band filter bank specific to a frequency band b may be determined, which may be represented a matrix composed of a real part T_{b}^{r}(k, m) and an imaginary part T_{b}ⁱ(k, m).

The generation of an intermediate frequency domain output may be similar to that of an actual frequency domain output for the current frame as indicated in Equation (6). The difference is that the actual frequency band gains for the frequency bands are not determined yet. To obtain the intermediate frequency domain outputs, the frequency band gains may be preconfigured as some reasonable values. If it is desired to use the frequency band filter bank specific to a frequency band b when estimating the frequency band energy for the frequency band b, the frequency band gain gₚ(b) for the frequency band b may be set as a nonzero number, indicating that the filter bank specific to this band has impact on the output. In some examples, the frequency band gain gₚ(b) may be set as a real number, an imaginary number, or even a complex number. By way of example, the gain gₚ(b) may be set as 1 or 1i. Of course, it will be appreciated that any other nonzero value may also be possible. The frequency band gains for other frequency bands than the frequency band in question may be set as 0, which means that their corresponding frequency band filter banks are not used.

In the example where the frequency band gₚ(b) for the frequency band b is set as 1 and the frequency band gains for other frequency bands are set as 0, Equation (6) may be modified to calculate the intermediate frequency domain output based on each of the frequency parameters as follows:

$${Y}_{pb}^{′} ( k ) = {\sum }_{m = 0}^{M - 1} {X}_{p - m} ( k ) {T}_{b}^{r} ( k , m ) \qquad ( 7 )$$

where Y_{pb}^{′}(k) represents the intermediate frequency domain output for the kth frequency bin of the pth frame that is associated with the bth frequency band. It is noted that if the frequency band gain gₚ(b) is set as an imaginary number, for example, 1i, then the imaginary part T_{b}ⁱ(k, m) of the complex matrix of the frequency band filter bank will be used for generating the output frequency domain output.

For each of the frequency parameters corresponding to the frequency bins associated with the frequency band b, an intermediate frequency domain output may be determined. In the cases where one or more previous frames are considered, the frequency parameters for the frequency band b may include not only the frequency parameters of the current frame, but also the frequency parameters of the one or more previous frames. Each of the frequency bands may be associated with one or more frequency bins of each of the previous frames. The frequency parameters of the previous frames that are corresponding to the associated frequency bins may be used to calculate the intermediate frequency domain outputs for the frequency band. It will be appreciated that although the intermediate frequency domain outputs are calculated based on the frequency parameters of the current frame and the frames prior to the current frame in the example of Equation (7), the intermediate frequency domain outputs may also be determined based on the frequency parameters of the current frame only in some other examples.

In some embodiments, the intermediate frequency domain outputs may be generated for the low frequency bands only. That is, the set of the frequency bands in step 120 may include one or more low frequency bands of the current frame. This may be applicable in the case where only the low frequency part of the current frame is required to be processed or in the case where the computation capacity is limited. For the latter case, it is because the determining of the frequency band energies using the frequency band filter banks may cost more computation complexity compared to the determining of the frequency band energies directly based on the frequency parameters. Since the inaccurate frequency band energy estimate usually occurs in the low frequency part if the estimate is directly based on the frequency parameters, the costly frequency band energy estimate may be applied to one or more low frequency bands only so as to improve the accuracy and save the computation cost.

In the example where the sampling rate of the audio signal is 48000 Hz and the length of the time-frequency domain is N=64, the first ten frequency bands with 2 ERB bandwidth may only cover the first four frequency bins. Thus, for each of the ten frequency bands, at most four intermediate frequency domain outputs Yₚ^{′}(k) for the associated first four frequency bins may be calculated. Moreover, for some of the ten frequency bands, for example, for the first four frequency bands, only one intermediate frequency domain output for the associated first frequency bin may be calculated. It will be appreciated that the corresponding intermediate frequency band outputs may be generated for each of the frequency bands of the current frame so as to calculate to frequency band energy.

The method 100 proceeds to step 130, where frequency band energies for the set of predefined frequency bands are determined based on the intermediate frequency domain outputs. If one or more intermediate frequency domain outputs are generated for each of the frequency bands, the frequency band energy for the frequency bands may be determined as the sum or the sum of squares of those intermediate frequency domain outputs. In the example of determining based on the sum of squares, for the frequency band b to be processed, its frequency band energy may be determined as follows:

$${E}_{p} ( b ) = {\sum }_{k = Bs}^{Be} {\vert {Y}_{pb}^{′} ( k ) \vert}^{2} \qquad ( 8 )$$

where Eₚ(b) represents the frequency band energy for the bth frequency band of the pth frame, and Bₛ and Bₑ represent the first and last frequency bins associated with the bth frequency band, respectively.

After determining the frequency band energies for the set of the frequency bands, in step 140, the current frame is processed based on the determined frequency band energies. If only the frequency band energies for the low frequency bands of the current frame are determined in steps 120 and 130 and it is required to process the low frequency bands of the current frame only, then the processing of the current frame may be based on the frequency band energies for the low frequency bands.

If the whole frequency range of the current frame is required to be processed and only the frequency band energies for one or more low frequency bands are determined in steps 120 and 130 for the purpose of saving the computation cost, the frequency band energies for other frequency bands than the low frequency bands may be determined directly based on the frequency parameters of the current frame. Specifically, each of the frequency bands may be associated with one or more frequency bins and then the frequency band energy for this frequency band may be determined as the sum or the same of squares of the frequency parameters corresponding to the associated frequency bins, which may be represented as the above Equation (1). The frequency band energies of all the frequency bands of the current frame may then be used to process the current frame. The processing of the current frame based on the frequency band energies may be described in more detail below.

By implementing the method 100, embodiments disclosed herein can process audio signal with less latency. As mentioned above, it is required for those known solutions to estimate the frequency band energy for each frequency band directly based on the frequency parameters corresponding to the associated frequency bins, which will result in inaccurate frequency band energy estimate, especially for the low frequency bands. Such frequency band energy estimate is not suitable to be applied to the audio signal processing systems having the processing parameters with low latency characteristic to meet the quality requirement. To the contrary, in accordance with embodiments disclosed herein, a predefined frequency band filer bank is utilized first to process the frequency parameters corresponding to the frequency bins associated with each frequency band to obtain the intermediate frequency domain outputs, so that the frequency parameters are adapted for the frequency band. Then, the frequency band energy for each frequency band may be estimated based on the intermediate frequency domain outputs for this frequency band.

Therefore, the frequency band energy estimated in accordance with the embodiments disclosed herein may reflect the specific characteristic of each frequency band correctly, which will be advantageous for the subsequent audio signal processing. In addition, the accuracy of the frequency band energy estimate may not be reduced even if the values of the time-frequency processing parameters are decreased, which is more advantageous for the audio signal processing systems having small time-frequency processing parameters, such as a shorter length of the time-frequency transform, the smaller number of audio samples processed per iteration, and/or a shorter length of the crossfading.

Although it is mentioned above that the method of frequency band energy estimate in the example embodiments disclosed herein is suitable for the audio signal processing systems having small time-frequency processing parameters, it will appreciated that the method is also applicable to the audio signal processing signal with any values of the time-frequency processing parameters, so as to improve the accuracy of the frequency band energies.

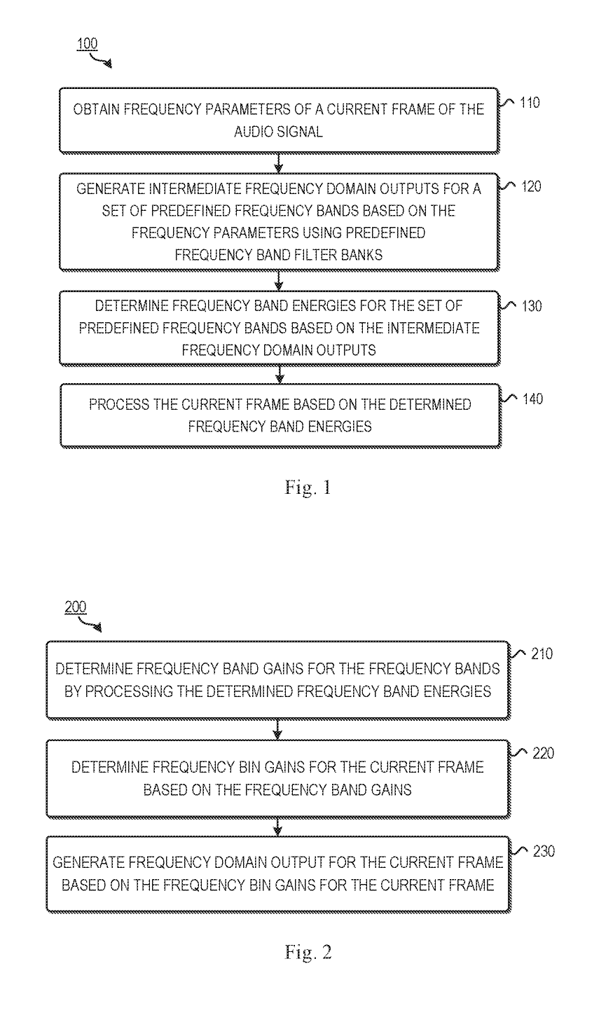

Now reference is made to FIG. 2, which depicts a flowchart of a method 200 of processing an audio signal in accordance with another example embodiment disclosed herein. It will be appreciated that the method 200 can be considered as a specific example embodiment of the method 100 as discussed above. Specifically, in the embodiment shown in FIG. 2, a current frame of the audio signal is processed based on the frequency band energies for the frequency bands of the current frame.

In step 210, frequency band gains are determined for the set of predefined frequency bands by processing the determined frequency band energies. In some embodiments disclosed herein, processing of one or more frequency band energies may be done by any suitable frequency domain audio processing techniques, including but not limited to equalizer processing, regulator processing, peak limiting processing, and so forth. Accordingly, the equalizer, regulator, peak limiter or any other devices, no matter currently known or developed in the future, may be used in connection with embodiments disclosed herein. Specifically, in some embodiments, in order to generate frequency band gains, the frequency band energies may be processed according to one or more parameters of a playback device for playing back the audio signal, thereby achieving the device specific audio signal processing. Lots of techniques for generating frequency band gains by processing frequency band energies are known and can be used in connection with embodiments disclosed herein. The scope of the subject matter disclosed herein is not limited in this regard.

In step 220, frequency bin gains are determined for the current frame based on the frequency band gains. As discussed above, frequency band filter banks specific to the predefined frequency bands may be designed in advance. Those frequency band filter banks may be used to generate the frequency bin gains for the frequency bins of the current frame based on the frequency band gains. The frequency band filter banks used for determining the frequency bin gains may have the same impulse responses to those used for estimating the frequency band energies, but the frequency band gains for the frequency bands are already determined here. By applying such frequency band filter banks to the frequency band gains, a plurality of frequency bin gains in the form of filter coefficients may be obtained, which may be represented, for example, as the above Equation (3).

In step 230, frequency domain output for the current frame is generated based on the frequency bin gains for the current frame. Given the frequency bin gains, frequency domain output for the current frame can be determined, for example, by multiplying the frequency bin gains by the respective frequency bins. Specifically, in some embodiments, the frequency domain output for the current frame may be determined merely based on the frequency bins for the current frame, which may be represented, for example, as the above Equation (4). In some alternative embodiments, the frequency domain output for the current frame may be determined based on the frequency bin gains not only for the current frame but also for at least one previous frame of the audio signal, which may be represented, for example, as the above Equation (5) or (6).

In some alternative embodiments, the intermediate frequency domain outputs calculated when estimating the frequency band energies may be stored for generating the actual frequency domain output for the current frame. When the frequency band gains are determined based on the estimated frequency band energies in step 210, the frequency band gains may be directly applied to the intermediate frequency domain outputs to obtain the final frequency domain output. In this case, steps 220 and 230 may be omitted. Supposed that only the real frequency band gains are required and the intermediate frequency domain outputs are calculated in the example of Equation (7), the generation of the final frequency domain output for a frequency bin of the current frame p based on the intermediate outputs may be represented as below:

$${Y}_{p} ( k ) = {\sum }_{b = 0}^{B - 1} R ( {g}_{p} ( b ) ) {Y}_{pb}^{′} ( k ) \qquad ( 9 )$$

In some embodiments, if the intermediate frequency domain outputs for some of the frequency bands of the current frame are generated, then those intermediate outputs may be used to determine a first frequency domain output for a frequency bin of the current frame in a similar way as in Equation (9). The first frequency domain output may indicate the contribution of those frequency bands corresponding to the intermediate outputs. For the other frequency bands of the current frame, a second frequency domain output for the same frequency bin may be determined in a similar way as discussed with reference to FIG. 2. The first and second frequency outputs may then be summed together to obtain the final frequency domain output for that frequency bin.

In some embodiments, the obtained frequency domain signal Yₚ (k) may be directly used as the final output. Alternatively, the frequency domain crossfading may be applied to the signal Yₚ(k) to obtain the final frequency domain output for the current frame. In this way, it is possible to get more smooth and continuous transition from one frame to another, with minimized clicks or other audible artifacts.

In some embodiments, the frequency domain output for the current frame is transformed to the time domain to generate the time domain output for the current frame. Here the frequency-time transform is an inverse transform of the time-frequency transform that is used. For example, in those embodiments where the MDFT function is used as the time-frequency transform, the frequency domain output may be transformed back to the time domain with Inverse Modulated Discrete Fourier Transform (IMDFT). The obtained time domain audio signal may be directly played back. Alternatively, it is possible to perform time domain processing on the obtained time domain audio signal. In some embodiments, the time domain processing may include time domain crossfading.

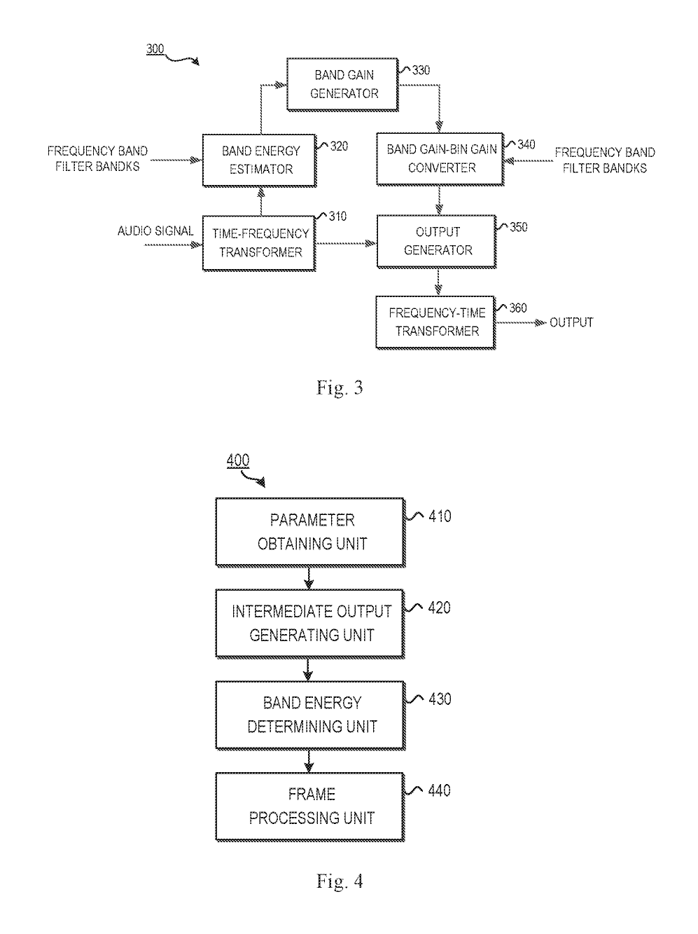

FIG. 3 depicts a block diagram of a system for processing an audio signal 300 in accordance with one example embodiment disclosed herein. As shown, the system 300 includes a time-frequency transformer 310, a band energy estimator 320, a band gain generator 330, a band gain-bin gain converter 340, an output generator 350, and a frequency-time transformer 360. It will be appreciated that the system 300 is shown for the purpose of illustration, which will be used to implement the method 100 and/or method 200 of processing an audio signal as described above.

The time-frequency transformer 310 of the system 300 may be configured to transform a current frame of the input time-domain audio signal into the frequency domain so as to obtain frequency parameters of the current frame. The time-frequency transformer 310 may be used to perform step 110 of the method 100 as described above. In the cases where the frequency parameters of the current frame in the frequency domain can be directly obtained from other sources, the time-frequency transformer 310 may be omitted.

The band energy estimator 320 may be configured to obtain the frequency parameters of the current frame and determine frequency band energies for predefined frequency bands of the current frame based on the frequency parameters using predefined frequency band filter banks. The band energy estimator 320 may be used to perform steps 120 and 130 of the method 100 as described above. In some embodiments, the band energy estimator 320 may estimate the frequency band energies for one or more low frequency bands using the predefined frequency band filter banks and estimate the frequency band energies for other frequency bands directly based on the frequency parameters. In some other embodiments, the band energy estimator 320 may determine the frequency ban energy for each of the frequency bands using the predefined frequency band filter banks.

The frequency band energies estimated by the band energy estimator 320 may be provided to the band gain generator 330. The band gain generator 330 may be configured to generate frequency band gains for the frequency bands by processing the frequency band energies. The processing of one or more frequency band energies may be done by any suitable frequency domain audio processing techniques. The band gain generator 330 may be used to perform step 210 of the method 200 as described above.

The generated frequency band gains may be passed to the band gain-bin gain converter 340. The band gain-bin gain converter 340 may be configured to convert the frequency band gains to frequency bin gains for the current frame. In some embodiments, the band gain-bin gain converter 340 may obtain the frequency bin gains by applying the frequency band gains to the predefined frequency band filter banks. The band gain-bin gain converter 340 may be used to perform step 220 of the method 200 as described above.

The output generator 350 may be configured to receive the frequency bin gains from the band gain-bin gain converter 340 and the frequency parameters for the current frame from the time-frequency transformer 310 or other sources, and generate frequency domain output for the current frame by multiplying the frequency parameters by the respective frequency bin gains. The output generator 350 may be used to perform step 230 of the method 200 as described above.

The frequency domain output generated by the output generator 350 may be transformed by the frequency-time transformer 360 into the time domain. In some other embodiments, the frequency domain output from the output generator 350 may be used as the output of the system 300. In this case, the frequency-time transformer 360 may be omitted. In the system 300, the band gain generator 330, the band gain-bin gain converter 340, the output generator 350, and/or the frequency-time transformer 360 are used to perform the processing of the current frame of the audio signal based on the frequency band energies from the band energy estimator 320. That is, the band gain generator 330, the band gain-bin gain converter 340, and the output generator 350 may be used to perform step 140 of the method 100 as described above.

FIG. 4 depicts a block diagram of a system for processing an audio signal 400 in accordance with another example embodiment disclosed herein. As shown, the system 400 includes a parameter obtaining unit 410 configured to obtain frequency parameters of a current frame of the audio signal. In some embodiments, the parameter obtaining unit 410 may include the time-frequency transformer 310 as shown in the system 300 of FIG. 3.

The system 400 also includes an intermediate output generating unit 420 configured to generate intermediate frequency domain outputs for a set of predefined frequency bands based on the frequency parameters using predefined frequency band filter banks, and a band energy determining unit 430 configured determine to frequency band energies for the set of predefined frequency bands based on the intermediate frequency domain outputs. A frequency band filter bank being specific to a respective frequency band in the set. In some embodiments, the intermediate output generating unit 420 and the band energy determining unit 430 may include the band energy estimator 320 as shown in the system 300 of FIG. 3.

The system 400 further includes a frame processing unit 440 configured to the current frame based on the determined frequency band energies. In some embodiments, the frame processing unit 440 may include the band gain generator 330, the band gain-bin gain converter 340, the output generator 350, and/or the frequency-time transformer 360 as shown in the system 300 of FIG. 3.

In some embodiments, the intermediate output generating unit 420 may be configured to associate each frequency band in the set with at least one of a plurality of predefined frequency bins for the current frame and generate the intermediate frequency domain output for each frequency band in the set based on the frequency parameters corresponding to the associated at least one frequency bin using the frequency band filter bank specific to the frequency band.

In some embodiments, the intermediate output generating unit 420 may be configured to generate the intermediate frequency domain outputs for the set of predefined frequency bands further based on frequency parameters of at least one frame prior to the current frame using the predefined frequency band filter banks.

In some embodiments, the frame processing unit 440 may include a band gain determining unit configure to determine frequency band gains for the set of predefined frequency bands by processing the determined frequency band energies. The frame processing unit 440 may also include a bin gain determining unit configured to determine frequency bin gains for the current frame based on the frequency band gains and an output generating unit configured to generate frequency domain output for the current frame based on the frequency bin gains for the current frame.

In some embodiments, a frequency range of the current frame may be divided into a plurality of frequency bands, and the set of predefined frequency bands may include at least one low frequency band among the divided frequency bands.

In some embodiments, the band energy determining unit 430 may be configured to determine frequency band energies for other frequency bands among the divided frequency bands directly based on the frequency parameters of the current frame. In some embodiments, the frame processing 440 may be configured to process the current frame further based on the frequency band energies for the other frequency bands.

It is to be understood that the components of the system 300 and/or the system 400 may be a hardware module or a software unit module. For example, in some embodiments, the system may be implemented partially or completely as software and/or in firmware, for example, implemented as a computer program product embodied in a computer readable medium. Alternatively, or in addition, the system may be implemented partially or completely based on hardware, for example, as an integrated circuit (IC), an application-specific integrated circuit (ASIC), a system on chip (SOC), a field programmable gate array (FPGA), and so forth. The scope of the subject matter disclosed herein is not limited in this regard.

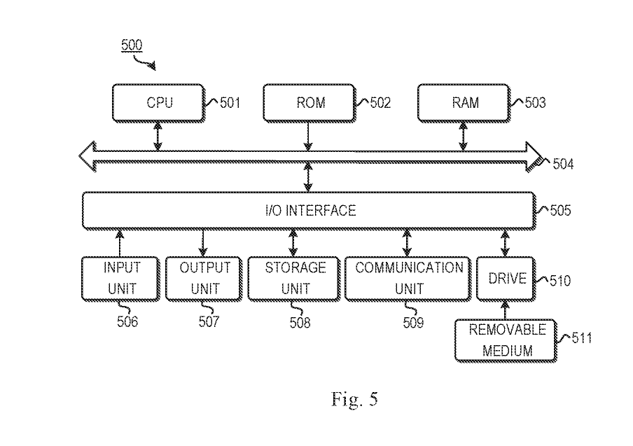

FIG. 5 depicts a block diagram of an example computer system 500 suitable for implementing example embodiments disclosed herein. As depicted, the computer system 500 includes a central processing unit (CPU) 501 which is capable of performing various processes in accordance with a program stored in a read only memory (ROM) 502 or a program loaded from a storage unit 508 to a random access memory (RAM) 503. In the RAM 503, data required when the CPU 501 performs the various processes or the like is also stored as required. The CPU 501, the ROM 502 and the RAM 503 are connected to one another via a bus 504. An input/output (I/O) interface 505 is also connected to the bus 504.

The following components are connected to the I/O interface 505: an input unit 506 including a keyboard, a mouse, or the like; an output unit 507 including a display such as a cathode ray tube (CRT), a liquid crystal display (LCD), or the like, and a loudspeaker or the like; the storage unit 508 including a hard disk or the like; and a communication unit 509 including a network interface card such as a LAN card, a modem, or the like. The communication unit 509 performs a communication process via the network such as the internet. A drive 510 is also connected to the I/O interface 505 as required. A removable medium 511, such as a magnetic disk, an optical disk, a magneto-optical disk, a semiconductor memory, or the like, is mounted on the drive 510 as required, so that a computer program read therefrom is installed into the storage unit 508 as required.

Specifically, in accordance with example embodiments disclosed herein, the method 100 or method 200 described above with reference to FIG. 1 or FIG. 2 may be implemented as computer software programs. For example, example embodiments disclosed herein include a computer program product including a computer program tangibly embodied on a machine readable medium, the computer program including program code for performing the method 100 or method 200. In such embodiments, the computer program may be downloaded and mounted from the network via the communication unit 509, and/or installed from the removable medium 511.

Generally speaking, various example embodiments disclosed herein may be implemented in hardware or special purpose circuits, software, logic or any combination thereof. Some aspects may be implemented in hardware, while other aspects may be implemented in firmware or software which may be executed by a controller, microprocessor or other computing device. While various aspects of the example embodiments disclosed herein are illustrated and described as block diagrams, flowcharts, or using some other pictorial representation, it will be appreciated that the blocks, apparatus, systems, techniques or methods disclosed herein may be implemented in, as non-limiting examples, hardware, software, firmware, special purpose circuits or logic, general purpose hardware or controller or other computing devices, or some combination thereof.

Additionally, various blocks shown in the flowcharts may be viewed as method steps, and/or as operations that result from operation of computer program code, and/or as a plurality of coupled logic circuit elements constructed to carry out the associated function(s). For example, example embodiments disclosed herein include a computer program product including a computer program tangibly embodied on a machine readable medium, the computer program containing program codes configured to carry out the methods as described above.

In the context of the disclosure, a machine readable medium may be any tangible medium that can contain, or store a program for use by or in connection with an instruction execution system, apparatus, or device. The machine readable medium may be a machine readable signal medium or a machine readable storage medium. A machine readable medium may include, but not limited to, an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing.

Computer program code for carrying out methods disclosed herein may be written in any combination of one or more programming languages. These computer program codes may be provided to a processor of a general purpose computer, special purpose computer, or other programmable data processing apparatus, such that the program codes, when executed by the processor of the computer or other programmable data processing apparatus, cause the functions/operations specified in the flowcharts and/or block diagrams to be implemented. The program code may execute entirely on a computer, partly on the computer, as a stand-alone software package, partly on the computer and partly on a remote computer or entirely on the remote computer or server. The program code may be distributed on specially-programmed devices which may be generally referred to herein as “modules”. Software component portions of the modules may be written in any computer language and may be a portion of a monolithic code base, or may be developed in more discrete code portions, such as is typical in object-oriented computer languages. In addition, the modules may be distributed across a plurality of computer platforms, servers, terminals, mobile devices and the like. A given module may even be implemented such that the described functions are performed by separate processors and/or computing hardware platforms.

As used in this application, the term “circuitry” refers to all of the following: (a) hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present. Further, it is well known to the skilled person that communication media typically embodies computer readable instructions, data structures, program modules or other data in a modulated data signal such as a carrier wave or other transport mechanism and includes any information delivery media.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the subject matter disclosed herein or of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination.

Various modifications, adaptations to the foregoing example embodiments disclosed herein may become apparent to those skilled in the relevant arts in view of the foregoing description, when read in conjunction with the accompanying drawings. Any and all modifications will still fall within the scope of the non-limiting and example embodiments disclosed herein. Furthermore, other embodiments disclosed herein will come to mind to one skilled in the art to which those embodiments pertain having the benefit of the teachings presented in the foregoing descriptions and the drawings.

It will be appreciated that the embodiments of the subject matter disclosed herein are not to be limited to the specific embodiments disclosed and that modifications and other embodiments are intended to be included within the scope of the appended claims. Although specific terms are used herein, they are used in a generic and descriptive sense only and not for purposes of limitation.

Various aspects of the present invention may be appreciated from the following enumerated example embodiments (EEESs):

EEE 1. A method of processing an audio signal, comprising:

obtaining frequency parameters of a current frame of the audio signal;

generating intermediate frequency domain outputs for a set of predefined frequency bands based on the frequency parameters using predefined frequency band filter banks, a frequency band filter bank being specific to a respective frequency band in the set;

determining frequency band energies for the set of predefined frequency bands based on the intermediate frequency domain outputs; and

processing the current frame based on the determined frequency band energies.

EEE 2. The method of EEE 1, wherein generating the intermediate frequency domain outputs for the set of predefined frequency bands comprises:

associating each frequency band in the set with at least one of a plurality of predefined frequency bins for the current frame; and

generating the intermediate frequency domain output for each frequency band in the set based on the frequency parameters corresponding to the associated at least one frequency bin using the frequency band filter bank specific to the frequency band.

EEE 3. The method of any of EEEs 1 to 2, wherein generating the intermediate frequency domain outputs for the set of predefined frequency bands comprises:

generating the intermediate frequency domain outputs for the set of predefined frequency bands further based on frequency parameters of at least one frame prior to the current frame using the predefined frequency band filter banks.

EEE 4. The method of any of EEEs 1 to 3, wherein processing the current frame comprises:

determining frequency band gains for the set of predefined frequency bands by processing the determined frequency band energies;

determining frequency bin gains for the current frame based on the frequency band gains; and

generating frequency domain output for the current frame based on the frequency bin gains for the current frame.

EEE 5. The method of any of EEEs 1 to 4, wherein a frequency range of the current frame is divided into a plurality of frequency bands, and the set of predefined frequency bands includes at least one low frequency band among the divided frequency bands.

EEE 6. The method of EEE 5, further comprising:

determining frequency band energies for other frequency bands among the divided frequency bands directly based on the frequency parameters of the current frame; and

wherein processing the current frame comprises:
processing the current frame further based on the frequency band energies for the other frequency bands.

EEE 7. A system for processing an audio signal, comprising:

a parameter obtaining unit configured to obtain frequency parameters of a current frame of the audio signal;

an intermediate output generating unit configured to generate intermediate frequency domain outputs for a set of predefined frequency bands based on the frequency parameters using predefined frequency band filter banks, a frequency band filter bank being specific to a respective frequency band in the set;

a band energy determining unit configured determine to frequency band energies for the set of predefined frequency bands based on the intermediate frequency domain outputs; and

a frame processing unit configured to the current frame based on the determined frequency band energies.

EEE 8. The system of EEE 7, wherein the intermediate output generating unit is configured to:

associate each frequency band in the set with at least one of a plurality of predefined frequency bins for the current frame; and

generate the intermediate frequency domain output for each frequency band in the set based on the frequency parameters corresponding to the associated at least one frequency bin using the frequency band filter bank specific to the frequency band.

EEE 9. The system of any of EEEs 7 to 8, wherein the intermediate output generating unit is configured to:

generate the intermediate frequency domain outputs for the set of predefined frequency bands further based on frequency parameters of at least one frame prior to the current frame using the predefined frequency band filter banks.

EEE 10. The system of any of EEEs 7 to 9, wherein the frame processing unit comprises:

a band gain determining unit configure to determine frequency band gains for the set of predefined frequency bands by processing the determined frequency band energies;

a bin gain determining unit configured to determine frequency bin gains for the current frame based on the frequency band gains; and

an output generating unit configured to generate frequency domain output for the current frame based on the frequency bin gains for the current frame.

EEE 11. The system of any of EEEs 7 to 10, wherein a frequency range of the current frame is divided into a plurality of frequency bands, and the set of predefined frequency bands includes at least one low frequency band among the divided frequency bands.

EEE 12. The system of EEE 11, wherein the band energy determining unit is configured to determine frequency band energies for other frequency bands among the divided frequency bands directly based on the frequency parameters of the current frame; and

wherein the frame processing is configured to process the current frame further based on the frequency band energies for the other frequency bands.

EEE 13. A device comprising:

a processing unit; and

a memory storing instructions that, when executed by the processing unit, cause the device to:
obtain frequency parameters of a current frame of the audio signal;
generate intermediate frequency domain outputs for a set of predefined frequency bands based on the frequency parameters using predefined frequency band filter banks, a frequency band filter bank being specific to a respective frequency band in the set;
determine frequency band energies for the set of predefined frequency bands based on the intermediate frequency domain outputs; and
process the current frame based on the determined frequency band energies.

EEE 14. The device of EEE 13, wherein the memory stores instructions that, when executed by the processing unit, further cause the device to:

associate each frequency band in the set with at least one of a plurality of predefined frequency bins for the current frame; and

generate the intermediate frequency domain output for each frequency band in the set based on the frequency parameters corresponding to the associated at least one frequency bin using the frequency band filter bank specific to the frequency band.

EEE 15. The device of any of EEEs 13 to 14, wherein the memory stores instructions that, when executed by the processing unit, further cause the device to:

generate the intermediate frequency domain outputs for the set of predefined frequency bands further based on frequency parameters of at least one frame prior to the current frame using the predefined frequency band filter banks.

EEE 16. The device of any of EEEs 13 to 15, wherein the memory stores instructions that, when executed by the processing unit, further cause the device to:

determine frequency band gains for the set of predefined frequency bands by processing the determined frequency band energies;

determine frequency bin gains for the current frame based on the frequency band gains; and

generate frequency domain output for the current frame based on the frequency bin gains for the current frame.

EEE 17. The device of any of EEEs 13 to 16, wherein a frequency range of the current frame is divided into a plurality of frequency bands, and the set of predefined frequency bands includes at least one low frequency band among the divided frequency bands.

EEE 18. The device of EEE 17, wherein the memory stores instructions that, when executed by the processing unit, further cause the device to:

determine frequency band energies for other frequency bands among the divided frequency bands directly based on the frequency parameters of the current frame; and

process the current frame further based on the frequency band energies for the other frequency bands.

EEE 19. A computer program product for processing an audio signal, comprising a computer program tangibly embodied on a machine readable medium, the computer program containing program code for performing the method according to any of EEEs 1-6.

1. A method of processing a sequence of frames of an audio signal, each of the frames representing a respective temporal portion of the audio signal, the temporal portion being no longer than 12.5 milliseconds in duration, the method comprising:
obtaining frequency parameters of a current frame of the audio signal;
generating respective intermediate frequency domain outputs for B₁ predefined frequency bands, B₁ being an integer greater than 1, based on the frequency parameters using predefined frequency band filter banks, a frequency band filter bank being specific to a respective frequency band of the B₁ predefined frequency bands, wherein
the respective filter banks for the B₂ lowest bands of the B₁ predefined frequency bands, B₂ being an integer less than B₁, are defined by a first function, the first function being a function of a first set of frequency parameters which comprises a) a first plurality of the frequency parameters of the current frame of the audio signal and b) a plurality of frequency parameters of at least one previous frame of the audio signal, and
the respective filter banks for the B₃ highest bands of the B₁ predefined frequency bands, B₃=B₁−B₂, are defined by a second function, the second function being a function of a second set of frequency parameters which comprises c) a second plurality of the frequency parameters of the current frame of the audio signal and d) none of the frequency parameters of any previous frame of the audio signal;
determining frequency band energies for the B₁ predefined frequency bands based on the intermediate frequency domain outputs; and
processing the current frame based on the determined frequency band energies,
wherein generating the intermediate frequency domain outputs for the B₁ predefined frequency bands comprises:
associating each of the B₁ predefined frequency bands with at least one of a plurality of predefined frequency bins for the current frame; and
generating the intermediate frequency domain output for each of the frequency bands based on the frequency parameters corresponding to the associated at least one frequency bin,
wherein the first function comprises a calculation of a weighted sum of the frequency parameters of the first set, and
wherein the first function is
$${Y}_{pb}^{′} ( k ) = {\sum }_{m = 0}^{M - 1} {X}_{p - m} ( k ) {T}_{b}^{r} ( k , m ) ,$$
wherein Y_{pb}^{′}(k) represents the intermediate frequency domain output for the kth frequency bin, of the pth frame, that is associated with the bth frequency band of the B₂ lowest bands,
wherein Xₚ₋ₘ(k) represents the frequency parameter for the kth frequency bin of the (p−m)th frame of the audio signal,
wherein M represents the number of frames being considered, including the current frame and the at least one previous frame of the audio signal, and
wherein T_{b}^{r}(k, m) represents a k×m matrix consisting of real valued weightings.

2. The method of claim 1 wherein the plurality of frequency parameters of the at least one previous frame of the audio signal consists of frequency parameters associated with the B₂ lowest bands of the B₁ predefined frequency bands of said at least one previous frame.

3. The method of claim 1 wherein the first function is adapted to provide entirely real output values.

4. The method of claim 1 wherein the second function is adapted to provide entirely real output values.

5. The method of claim 1, wherein said processing the current frame comprises:
determining frequency band gains for the B₁ predefined frequency bands by processing the determined frequency band energies;
determining frequency bin gains for the current frame based on the frequency band gains; and
generating a frequency domain output for the current frame based on the frequency bin gains for the current frame.

6. The method of claim 1 wherein processing the current frame comprises processing the current frame further based on the frequency band energies for the B₃ highest bands.

7. A system for processing a sequence of frames of an audio signal, each of the frames representing a respective temporal portion of the audio signal, the temporal portion being no longer than 12.5 milliseconds in duration, comprising:
a parameter obtaining unit configured to obtain frequency parameters of a current frame of the audio signal;
an intermediate output generating unit configured to generate intermediate frequency domain outputs for B₁ predefined frequency bands, B₁ being an integer greater than 1, based on the frequency parameters using predefined frequency band filter banks, a frequency band filter bank being specific to a respective frequency band of the B₁ predefined frequency bands, wherein
the respective filter banks for the B₂ lowest bands of the B₁ predefined frequency bands, B₂ being an integer less than B₁, are defined by a first function, the first function being a function of a first set of frequency parameters which comprises a) a first plurality of the frequency parameters of the current frame of the audio signal and b) a plurality of frequency parameters of at least one previous frame of the audio signal, and
the respective filter banks for the B₃ highest bands of the B₁ predefined frequency bands, B₃=B₁−B₂, are defined by a second function, the second function being a function of a second set of frequency parameters which comprises c) a second plurality of the frequency parameters of the current frame of the audio signal and d) none of the frequency parameters of any previous frame of the audio signal;
a band energy determining unit configured determine to frequency band energies for the B₁ predefined frequency bands based on the intermediate frequency domain outputs; and
a frame processing unit configured to process the current frame based on the determined frequency band energies,
wherein the intermediate output generating unit is configured to:
associate each of the B₁ predefined frequency bands with at least one of a plurality of predefined frequency bins for the current frame; and
generate the intermediate frequency domain output for each of the B₁ predefined frequency bands based on the frequency parameters corresponding to the associated at least one frequency bin using the frequency band filter bank specific to the frequency band,
wherein the first function comprises a calculation of a weighted sum of the frequency parameters of the first set, and
wherein the first function is
$${Y}_{pb}^{′} ( k ) = {\sum }_{m = 0}^{M - 1} {X}_{p - m} ( k ) {T}_{b}^{r} ( k , m ) ,$$
wherein Y_{pb}^{′}(k) represents the intermediate frequency domain output for the kth frequency bin, of the pth frame, that is associated with the bth frequency band of the B₂ lowest bands,
wherein Xₚ₋ₘ(k) represents the frequency parameter for the kth frequency bin of the (p−m)th frame of the audio signal,
wherein M represents the number of frames being considered, including the current frame and the at least one previous frame of the audio signal, and
wherein T_{b}^{r}(k, m) represents a k×m matrix consisting of real valued weightings.

8. The system of claim 7 wherein the plurality of frequency parameters of the at least one previous frame of the audio signal consists of frequency parameters associated with the B₂ lowest bands of the B₁ predefined frequency bands of said at least one previous frame.

9. The system of claim 7 wherein the first function is adapted to provide entirely real output values.

10. The system of claim 7 wherein the second function is adapted to provide entirely real output values.

11. The system of claim 7, wherein the frame processing unit comprises:
a band gain determining unit configure to determine frequency band gains for the B₁ predefined frequency bands by processing the determined frequency band energies;
a bin gain determining unit configured to determine frequency bin gains for the current frame based on the frequency band gains; and
an output generating unit configured to generate frequency domain output for the current frame based on the frequency bin gains for the current frame.

12. The system of claim 7,
wherein the frame processing is configured to process the current frame further based on the frequency band energies for the B₃ highest bands.

13. A computer program product for processing a sequence of frames of an audio signal, each of the frames representing a respective temporal portion of the audio signal, the temporal portion being no longer than 12.5 milliseconds in duration; the computer program product comprising a computer program tangibly embodied on a machine readable medium, the computer program containing program code for performing the method according to claim 1.
